(19) United States
(12) Patent Application Publication
(10) Pub. No.: US 2017/0119498 A1
(43) Pub. Date: May 4, 2017

(54) SELF-HEATING SLEEVE FOR A DENTAL CARTRIDGE OR SYRINGE

(71) Applicant: Centrix, Inc., Shelton, CT (US)

(72) Inventors: John DISCKO, Trumbull, CT (US); Pengguang Yu, Branford, CT (US)

(21) Appl. No.: 15/408,997

(22) Filed: Jan. 18, 2017

Related U.S. Application Data
(63) Continuation of application No. PCT/US2015/041431, filed on Jul. 21, 2015.
(60) Provisional application No. 62/068,078, filed on Oct. 24, 2014.
(60) Provisional application No. 62/027,277, filed on Jul. 22, 2014.

(51) Int. Cl. A61C 5/55; A61C 5/66; A61C 5/62

(52) U.S. Cl. CPC A61C 5/55; A61C 5/62; A61C 5/66; A61C 2202/00

(57) ABSTRACT

A self-heating chemically activated pouch formed to hold a medical or dental device or material prior to use or application. The pouch has a construction to readily receive a dental device or material, such as a tip or syringe containing a dental material or composite, permitting easy activation of an activator or trigger to initiate an exothermic chemical reaction of a heating material to heat the dental device or material. Heating the dental material or composite improves its flowability and properties.

### RELATED APPLICATIONS

This application is a continuation of International Application PCT/US2015/041431, with an international filing date of Jul. 21, 2015, which claims the benefit of U.S. Provisional Application Nos. 62/068,078 filed Oct. 24, 2014 and 62/027,277 filed Jul. 22, 2014, all of which are herein incorporated by reference.

### FIELD OF THE INVENTION

The present invention relates in general to use of dental materials, and particularly to heating of a dental material to improve comfort and material properties. The present invention also relates in general to a pouch for holding and heating a product, and particularly to a unit dose pouch for self-heating a dental composite contained within a capsule prior to use.

### BACKGROUND OF THE INVENTION

There are several areas where applied heat to a medical device or material will make the use of the device more comfortable or easier to use. One such application is in the injection and filling of composite resin restorative materials into teeth. These materials are densely filled, highly viscous, and difficult to place and conform to the cavity preparation. Application of heat to these materials will temporarily reduce the viscosity and improve the flow into the prepared cavity in the tooth.

Dental composite resins are normally packaged in bulk screw syringes or direct-injection, prefilled syringe tips or cartridges. At room temperature, these materials resist flow, and are often hard to extrude from their containers. Application of heat (100-130° F. or 37.8-54.4° C.) temporarily lowers the viscosity of these materials and makes them easier to use. In addition, there are additional clinical benefits to warming composite resins prior to placement. These include improvements in conversion rates and hardness.

There are currently electrical warming devices on the marketplace that are designed to heat bulk syringes or composite tips or cartridges. These are expensive and require access to an electrical outlet for use, making them stationary in the dental office. During a long procedure, the composite syringe or prefilled tip or cartridge may need to be returned to the unit for-re-heating on occasion. This is a disadvantage if the unit cannot be located chairside, next to the patient. In addition, the block heater can be considered a source of cross-contamination if used on multiple patients without proper asepsis procedure.

Therefore, there is a need for a convenient way to elevate the temperature of a medical device or material such as a dental composite prior to use in the restoration of a tooth.

### SUMMARY OF THE INVENTION

The present invention is a pouch having a chemically activated heating material. A self heating sleeve may be folded to form a pocket or pouch in which a tip or syringe containing a dental material to be heated may be placed. The heating material may be a liquid in contact with a mechanical activator or trigger that when manipulated triggers an exothermic reaction in the heating material quickly heating the tip of syringe containing a dental material to be heated to a predetermined temperature.

Accordingly it is an object of the present invention to heat a dental material providing advantageous properties prior to use.

It is an object of the present invention to provide a temperature that can quickly be reached and sustained for a period of time.

It is yet another object of the present invention to prevent overheating of a dental material by limiting the maximum temperature that can be reached by the heating material.

It is an advantage of the present invention that it is used without any electrical power.

It is another advantage of the present invention that is portable and has a small size.

It is yet another advantage of the present invention that it is relatively inexpensive making suitable for a single use.

Is a feature of the present invention that a heating material is activated by a trigger providing an exothermic reaction.

It is another feature of the present invention that it is folded to form a pocket to hold a tip or syringe containing a dental material.

It is yet another feature of the present invention that an extension extends from the self-heating sleeve permitting the trigger contained within the extension to be activated easily.

These and other objects, advantages, and features will become more readily apparent in view of the following more detailed description.

### BRIEF DESCRIPTION OF THE DRAWINGS

FIG. 1 is a perspective view schematically illustrating the present invention placed on a syringe having a mechanical advantage.

FIG. 2 is a partial cross section illustrating the present invention placed on a barrel of the syringe taken along line 2-2 in FIG. 1.

FIG. 3 is a front elevational view illustrating the present invention placed on the barrel of the syringe.

FIG. 4 is a partial cross section illustrating the present invention placed on a barrel of a bulk syringe.

FIG. 5A is an elevational view illustrating an embodiment of the present invention.

FIG. 5B is a plan view of the embodiment illustrated in FIG. 5A.

FIG. 5C is an elevational view illustrating formation of a cylinder in the embodiment illustrated in FIGS. 5A-B.

FIG. 6A is a perspective view illustrating another embodiment of the present invention.

FIG. 6B is a perspective view illustrating formation of a tube in the embodiment illustrated in FIG. 6A.

FIG. 7A is a perspective view schematically illustrating another embodiment of the present invention.

FIG. 7B is a perspective sectioned view schematically illustrating the embodiment illustrated in FIG. 7A.

FIG. 8 is a perspective view schematically illustrating another embodiment of the present invention.

FIGS. 9A-G schematically illustrates different activators or triggers for the self-heating pouch of the present invention.

FIG. 10 schematically illustrates an exposed portion of the present invention.

FIG. 11A is a plan view of another embodiment of the present invention.

FIG. 11B is a cross section taken along line 11B-11B in FIG. 11A.

FIG. 12A is a plan view of yet another embodiment of the present invention.

FIG. 12B is a cross section taken along line 12B-12B in FIG. 8.

FIG. 13 schematically illustrates another embodiment of the present invention.

FIGS. 14A-E schematically illustrates yet another embodiment of the present invention.

FIGS. 15A-B schematically illustrates still yet another embodiment of the present invention.

FIGS. 16A-B schematically illustrates another embodiment of the present invention.

FIGS. 17A-B schematically illustrates yet another embodiment of the present invention.

FIGS. 18A-C schematically illustrates still yet another embodiment of the present invention.

FIGS. 19A-B schematically illustrates yet another embodiment of the present invention.

FIGS. 20A-C schematically illustrates yet another embodiment of the present invention.

FIGS. 21A-D schematically illustrates different closure or attachment means for attaching portions of the present invention together.

### DETAILED DESCRIPTION OF THE INVENTION

An embodiment of the invention is a self-heating sleeve that wraps around the bulk syringe or syringe/tip combination, or a tubular sleeve that the syringe barrel can be easily inserted into. This sleeve can contain chemically-activated or air-activated components to generate heat. Upon activation, the syringe barrel is inserted, and is instantly surrounded by the heat source. One common source of heat is used in commercially available hand warmer packets, such as those made by HeatMax Inc, Dalton, Ga. Heat is generated when the sealed package is opened and the components (iron powder, water, salt, activated charcoal and vermiculite) react with oxygen. Within 15-30 minutes, the internal temperature reaches 130° F. or 54.4° C. and lasts up to 10 hours.

The present invention may be used with a dental cartridge and syringe system as disclosed in U.S. Pat. No. 5,165,890 entitled “Dosing Dental Cartridge” issuing to Discko, Jr. on Nov. 24, 1992 and U.S. Pat. No. 5,489,207 entitled “Dental Cartridge Extruder with Rigid Drop-in Front End” issuing to Dragon et al. on Feb. 6, 1996, both of which are herein incorporated by reference.

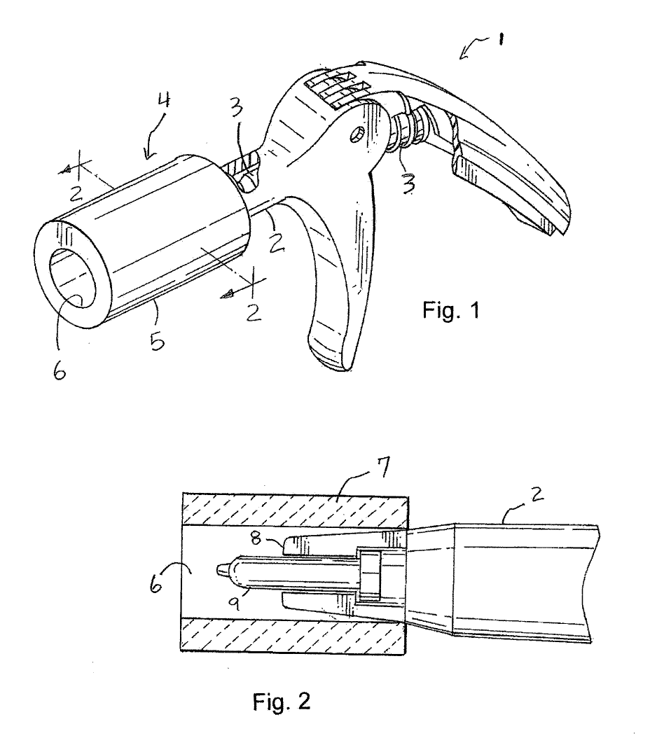

FIG. 1 illustrates the application of the present invention on a dental syringe 1 having a mechanical advantage. The dental syringe 1 has a barrel 2 containing a reciprocating plunger 3 used to extrude a dental material from a dental cartridge. A self-heating sleeve 4 is placed over a portion of the barrel 2 holding a dental cartridge containing the dental material to be extruded. FIG. 1 illustrates the self-heating sleeve comprising a cylinder 5 having a bore 6. The cylinder 5 and bore 6 has an internal diameter and longitudinal length adapted to be placed over and securely held on the barrel 2 of the dental syringe 10. Accordingly, upon activation of the self-heating sleeve 4 the entire area around the dental cartridge or tip is heat.

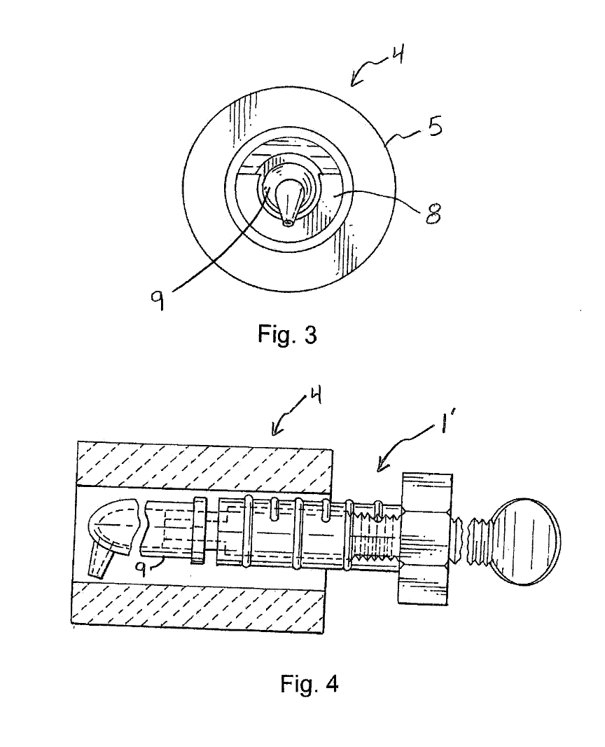

FIG. 2 is a partial cross section taken along line 2-2 in FIG. 1 and more clearly illustrates the placing of the self-heating sleeve 4 on the barrel 2 and around the dental cartridge or tip 9 the dental cartridge or tip 9 is held within the distal end 8 of the barrel 2 and is positioned within the bore 6 of the self-heating sleeve 4. Between the outer circumference and the inner circumference of the cylinder 5 is a self-heating material 7. The self-heating material 7 preferably has a chemical composition that upon activation will generate heat providing a temperature in the range of between 98° and 155° F. or 36.7 and 68.3° C., and preferably approximately 135° F. or 57.2° C., for at least the time required for performing a dental procedure.

The self-heating material 7 is preferably activated by exposure to air. Therefore, the material forming the cylinder 5 of the self-heating sleeve is preferably air permeable so that when the self-heating material 7 is desired to be activated an air-impermeable cover, not shown, is removed exposing the self-heating material 7 to air. That is, the self-heating sleeve 16 may be initially wrapped are contained within a material or container impervious to air, so that when opened the self-heating material 7 contained within the sleeve is activated generating heat. However, the self-heating material 7 may be any material that can be activated to generate heat by other chemical means, such as combining two different components or to for an exothermic process to be activated by a trigger. A sleeve may also be used that stores heat energy or has a thermal mass, so that once heated can be placed around the dental cartridge or tip.

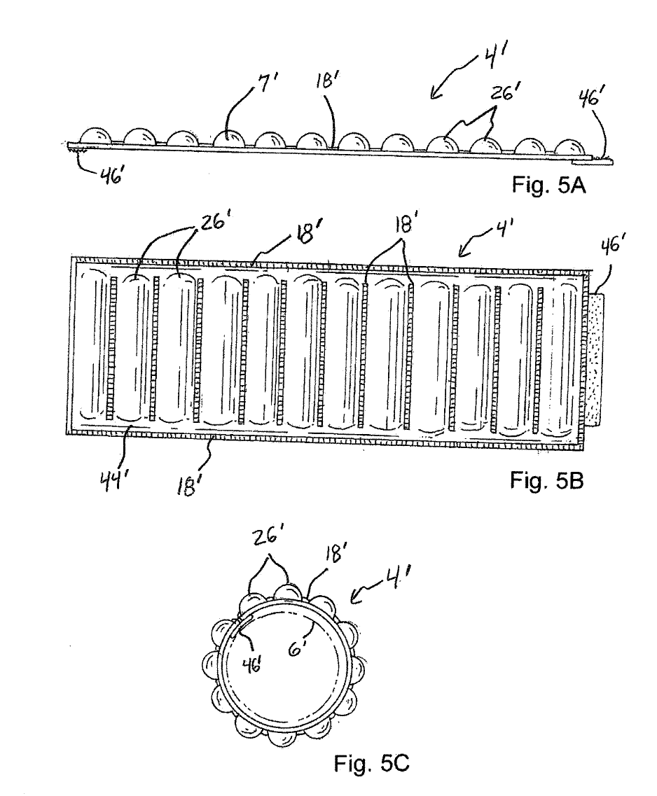

FIG. 3 is a front elevational view illustrating the cylinder 5 of the self-heating sleeve 4 wrapped around the dental cartridge or tip 9 held within the distal end 8 of the barrel of the dental syringe 1, illustrated in FIG. 1.

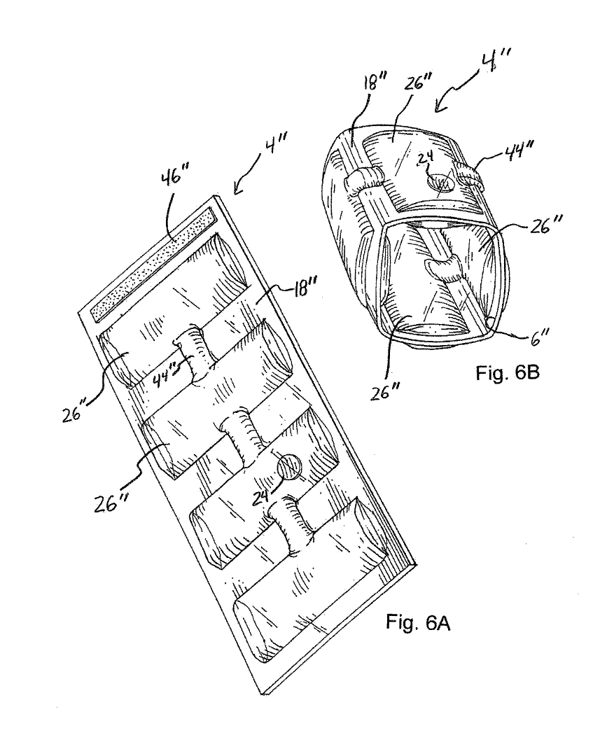

The present invention may be used in other applications to heat dental materials and other devices. For example, FIG. 4 illustrates the self-heating sleeve 4 being adapted to be held onto a bulk cartridge 1′ having a dental cartridge or tip 9 contained thereon. The bulk cartridge 1′ is often used to dispense a dose of a dental material from a syringe containing multiple doses of the dental material.

By varying the chemical composition of the self-heating material different temperature ranges may be obtained for different durations depending upon the application. Accordingly, the self-heating sleeve of the present invention may be used to warm medications or other materials entering the human body to a temperature similar to body temperature so as to prevent any possible discomfort to the patient. For example the self-heating material and self-heating sleeve may be adjusted or adapted for placement on a medical device to warm a liquid medicament to body temperature prior to being injected. This is particularly applicable to anesthetics.

The heated sleeve could be used to warm anesthetic carpules or carpule syringes prior to injection. Studies indicate that warmed anesthetic, closer to body temperature, provides for a less painful injection. Anesthetic carpule warmers, using either an electrical heat block or a simple electrical light bulb, have been available to the profession for many years.

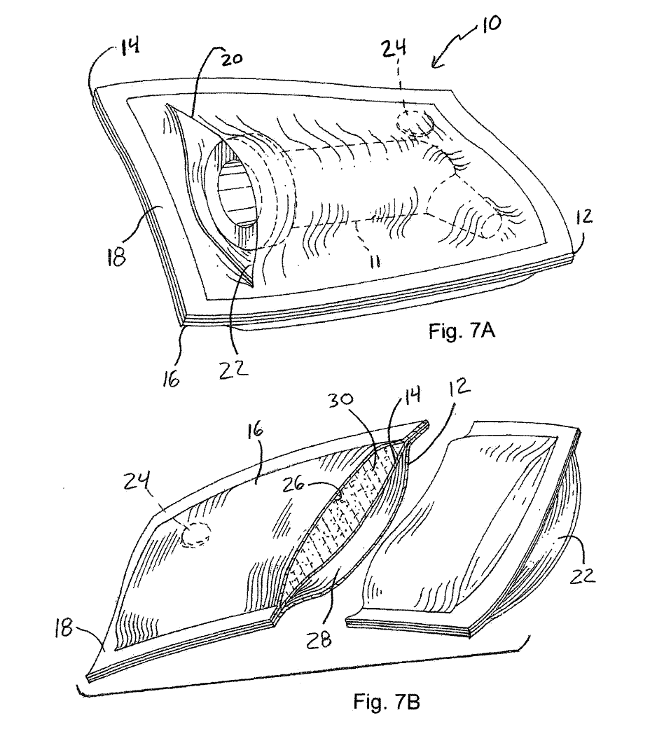

FIGS. 5A-C illustrates another embodiment of the invention. FIG. 5A is an elevational view illustrating a self-heating sleeve 4′ having heating material pockets 26′ separate rated by a seal 18′. Placed within each of the heating material pockets 26′ is a self-heating material 7′ that may be chemically activated or triggered to begin an exothermic reaction. On each end of the self-heating sleeve 4′ our attachment means 46′. The attachment means 46 possibly may be an adhesive, hook and loop fastener, or other equivalent fastener. FIG. 5B is a plan view illustrating the self-heating sleeve 4′. This view more clearly illustrates the seals 18′ separating the plurality of heating material pocket 26′. A channel 44′ extends between each of the heating material pocket 26′. The channel 44′ permits a continuous path between the heating material pocket 26′ so that upon triggering or activating a self-heating material 7′ contained therein all of the self-heating material 7′ is activated. FIG. 5C illustrates the attachment of the attachment means 46′ formed on either end of the self-heating sleeve 4′ forming a cylinder having a bore 6′. A dental cartridge or tip or dental syringe may be placed within the bore 6′ to heat up a dental material contained therein.

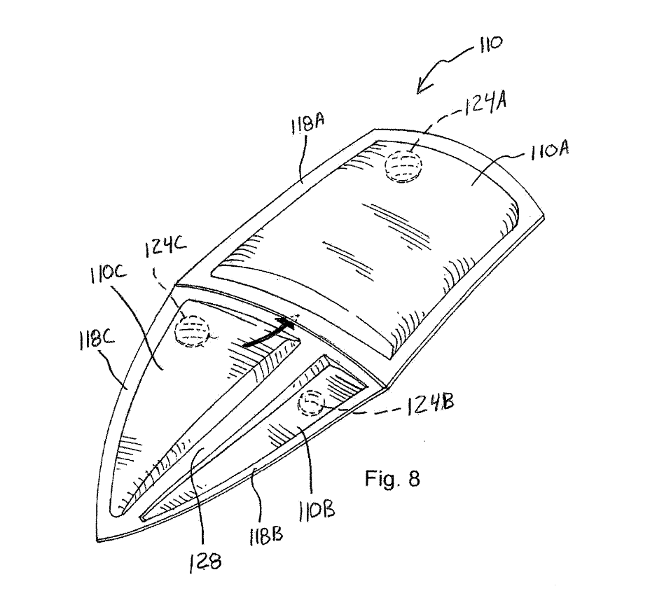

FIGS. 6A-B illustrates another embodiment of a self-heated sleeve 4″ having heating material pockets 26″ and seals 18′. Centrally located between each heating material pockets 26″is a channel 44″. The channels 44″ permit communication flow between each of the heating material pockets 26″. A trigger 24 is contained within one of the heating material pockets 26″, so that a heating material contained within the heating material pockets 26″, which may be a liquid, can be activated by the trigger 24. A suitable heating material is more fully described in reference to other embodiments of the present invention. An attachment means 46″ is attached to one or both ends of the self-heating sleeve 4″. FIG. 6B illustrates the self-heating sleeve 4″ formed into a tube having a bore 6″ by attaching the ends together with the attachment means 46″.

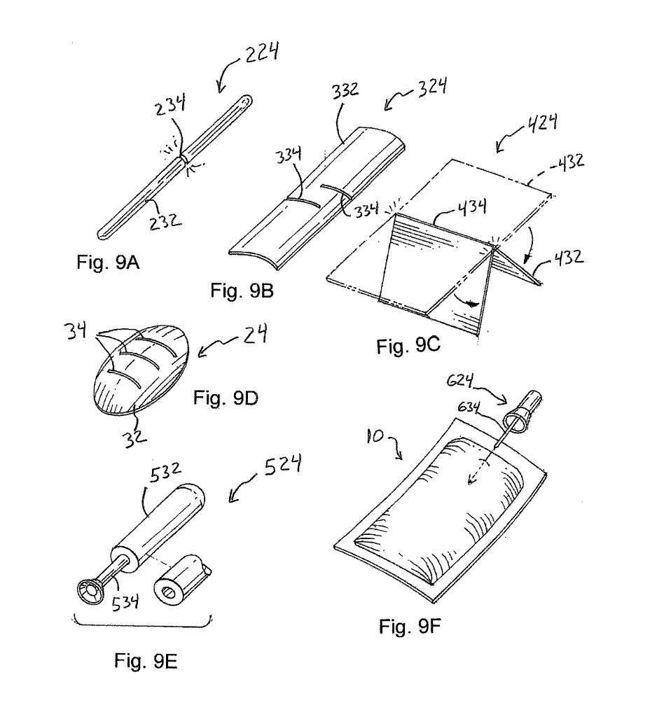

FIG. 7A is a perspective view illustrating another embodiment of the present invention. The self-heating product pouch is made of a top layer 12, a middle layer 14, and a bottom layer 16. A seal 18 around the perimeter of the self-heating product pouch 10 seals the three layers 12, 14, and 16 together. The three layers form two pockets, a product pocket and a heating material pocket. The product pocket preferably contains a product to be heated, such as a capsule 11 containing a dental composite or other material. The capsule 11 may be a dental capsule as disclosed in U.S. Pat. No. 6,877,983 issuing to Dragan et al. on Apr. 12, 2005 and entitled “Dental Capsule for Placement of High Viscosity Dental Composite Material with Reduced Extrusion Force”, which is herein incorporated by reference. A cut or slit 20 forms an opening 22 for accessing the product pocket with the capsule 11 contained therein. An activator or trigger 24 is used to activate the heating material contained in a heating material pocket adjacent to or opposing the product pocket.

FIG. 7B illustrates the sectioning of the self-heating product pouch 10 and more clearly illustrates the heating material pocket 26 and the product pocket 28. The heating material pocket 26 contains a heating material 30 that is activated by an activator or trigger 24. The heating material 30 is sealed within the heating material pocket 26 between the middle layer 14 and the bottom layer 16. The heating material 30 may be any self-contained or chemically activated heating material. For example, one such heating material is supersaturated sodium acetate dissolved in water. When a crystallization process is triggered using an activator or trigger 24, such as a metal disc, sodium acetate becomes sodium acetate trihydrate. When sodium acetate trihydrate with/without adding a small amount of water is heated past the melting point and subsequently allowed to cool, the aqueous solution becomes supersaturated. Supersatuation is a state of a solution in which more material is dissolved than what is normally dissolved in a solvent, in this case, the solvent is water. The supersaturated sodium acetate solution is capable of staying stable at room temperature without forming crystals. By pressing on a trigger 24 or metal disc within the heating pouch 10, a new surface at the surface of a slot on the metal disc is exposed, thereafter, a nucleation center is formed, causing the solution to crystallize back into solid sodium acetate trihydrate. Sodium acetate trihydrate crystals have a melting temperature of 137.12° F. or 58.4° C., when melted, it is dissolved in their water of crystallization. During the process in which supersaturated sodium acetate is crystallizing, the solution contains both crystal of sodium acetate trihydrate and water. Therefore, the temperature of the mixture remains at 137.12° F. or 58.4° C. The bond-forming process of crystallization is exothermic, it releases heat. As a result, the heating material heats up surrounding materials to the same temperature at 137.12° F. or 58.4° C. until the crystallization process is completed.

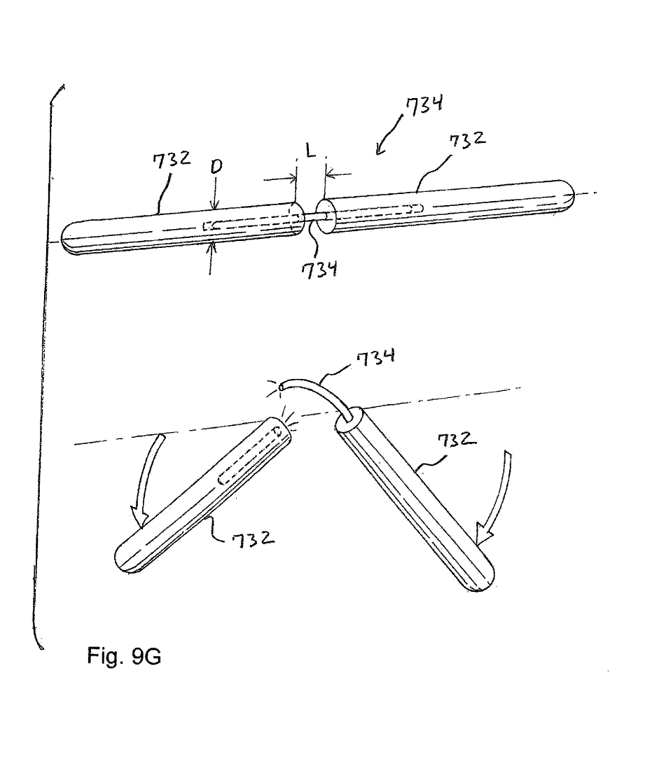

FIG. 8 illustrates another embodiment of the present invention. In this embodiment a plurality of self-heating pouches are folded to form a pocket 128 in which a product may be placed for heating, such as a capsule, syringe or other device. The self-heating pouches 110 are attached together. The self-heating pouches 110A, 110B, and 110C are sealed by seals 118A, 118B, and 118C. Placed in each respective one of the self-heating pouches 110A, 110B, and 110C is an activator or trigger 124A, 124B, 124C. The activators or triggers 124A, 124B, 124C are in contact with a heating material contained in the respective self-heating pouches 110A, 110B, and 110C. In an alternative embodiment, only one activator or trigger may be used in one of the self-heating pouches 110A, 110B, or 110C, with the pouches connected by a channel formed by an unsealed portion so as to interconnect the self-heating pouches 110A, 110B, and 110C. The heating material contained in the respective self-heating pouches 110A, 110B, and 110C can then be activated by the one activator or trigger and the nucleation of the heating material progressing through the channels to all of the self-heating pouches 110A, 110B, and 110C. In this embodiment only a single activator or trigger is required. The self-heating pouches 110A, 110B, and 110C are folded over to form the pocket 128 for receiving a product or device to be heated. This embodiment of the invention may accommodate larger products or devices.

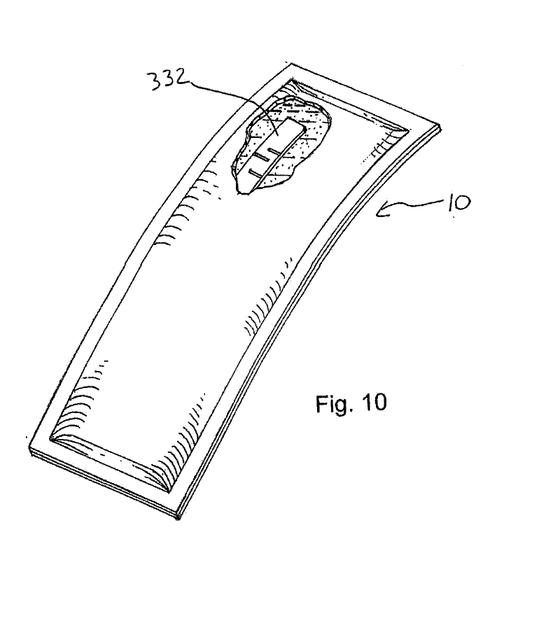

FIGS. 9A-G illustrates different activators or triggers that create a new surface of activating material to activate or trigger a chemical reaction or crystallization in a heating material. FIG. 9A illustrates an activator or trigger 224 comprising a rod 232 and a breaking point 234 for creating a new surface. FIG. 9B illustrates an activator or trigger 324 comprising a sheet 332 having cuts 334 formed therein for twisting so as to form a new surface. FIG. 9C illustrates an activator or trigger 424 comprising a sheet 432 having a bend 434 for forming a new surface. FIG. 9D illustrates an activator or trigger 24 comprising a metal disc 32 having a slot 34 for forming a new surface. FIG. 9E illustrates an activator or trigger 524 comprising a cylinder or barrel 532 having a through hole with a plug or rod 534 therein for forming a new surface when the rod is pulled from the through hole or pushed through the hole and a new surface is exposed at the other end of the cylinder or barrel 532. FIG. 9F illustrates an activator or trigger 624 comprising a pin 634. When the pin 634 is pushed into and punctures the pouch 10 a heating material contained therein is activated. Because the formation of crystals in the heating material once activated occurs quickly, the pouch with not leak. FIG. 9G illustrates an activator or trigger 724 that is activated by bending. A wire 734 is inserted into adjacent ends of two adjoining plastic rods 732. Upon bending the two adjoining plastic rods 732 relative to each other, a new portion of the wire 734 is exposed acting as a trigger to form crystals in the heating material. Any one of these activators or triggers may be used to activate, trigger, or initiate the exothermic reaction generating heat in the heating material.

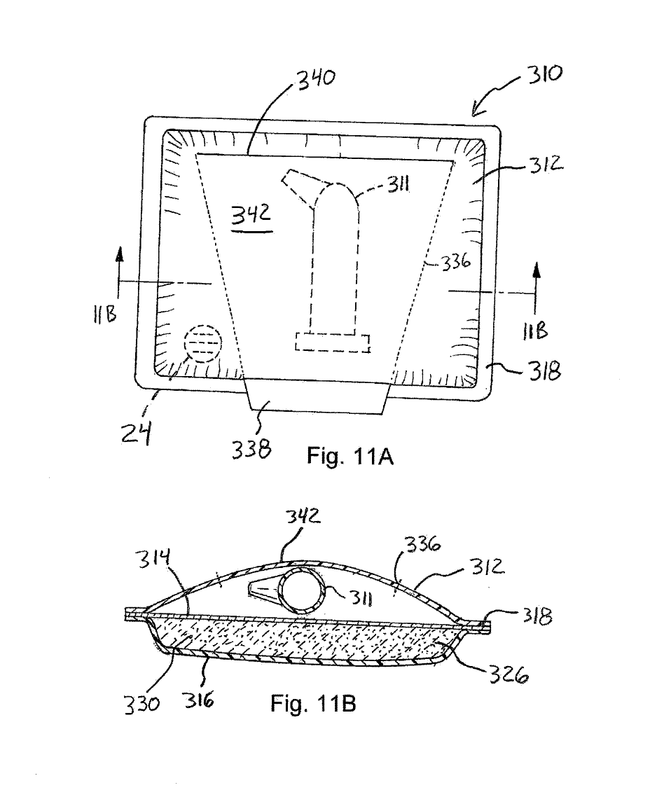

FIG. 10 illustrates embodiment of the invention using an activator or trigger 332. The activator or trigger 332 may be twisted to expose a new surface for activating or triggering the exothermic reaction in the heating material.

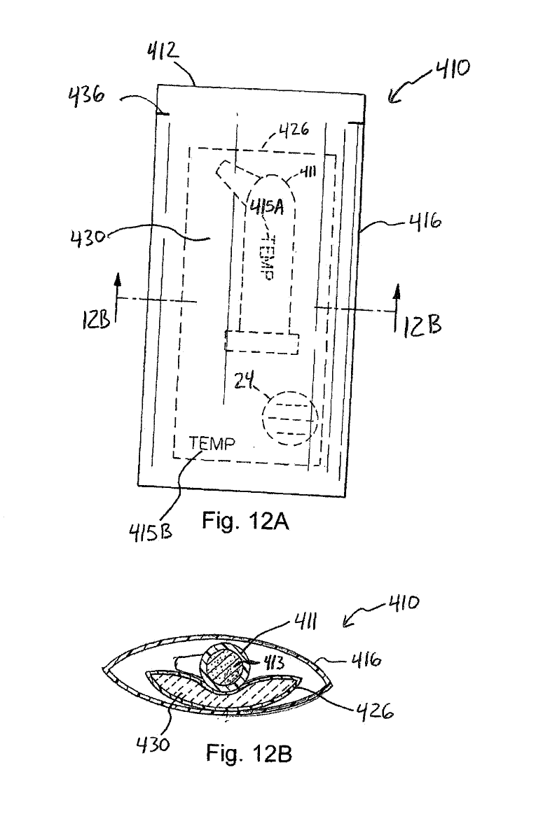

FIGS. 11A-B illustrates another embodiment of the invention that may be easily opened. The self-heating product pouch 310 has a product or capsule 311 placed under an opening cover 342 within a product pocket 328. The opening cover 342 has a pull tab 338 extending over an edge of the self-heating product pouch 310. Perforations 336 formed in the top layer 312 provide easy separation of the opening cover 342 from the top layer 312 permitting the product or capsule 311 to be removed from the product pocket 328. Below the product or capsule 311 is the heating material 330 sealed with the heating material pocket 326 between the middle layer 314 and the bottom layer 316. The perimeter of the self-heating product pouch 310 is sealed by seals 318. The seals 318 may be thermoformed. The heating material 330 is activated by an activator or trigger 24 contained within the heating material pocket 326. In this embodiment of the present invention the product or capsule 311 may be prepackaged in a unit dose self-heating product pouch 310. Just prior to the intended use of the product or capsule 311 the activator or trigger 24 may be bent or twisted activating the exothermic reaction in the heating material 330. After a predetermined time sufficient to heat the product or capsule 311 the pull tab 338 may be used to open the opening cover 342 exposing the heated product or capsule 311 permitting its removal for use in dispensing the heated dental composite material contained therein. The dental composite material contained therein may be extruded with the use of a dental syringe, such as that disclosed in U.S. Pat. No. 5,489,207 issuing to Dragan et al. on Feb. 6, 1996 entitled “Dental Cartridge Extruder with Rigid Drop-In Front End”, which is herein incorporated by reference.

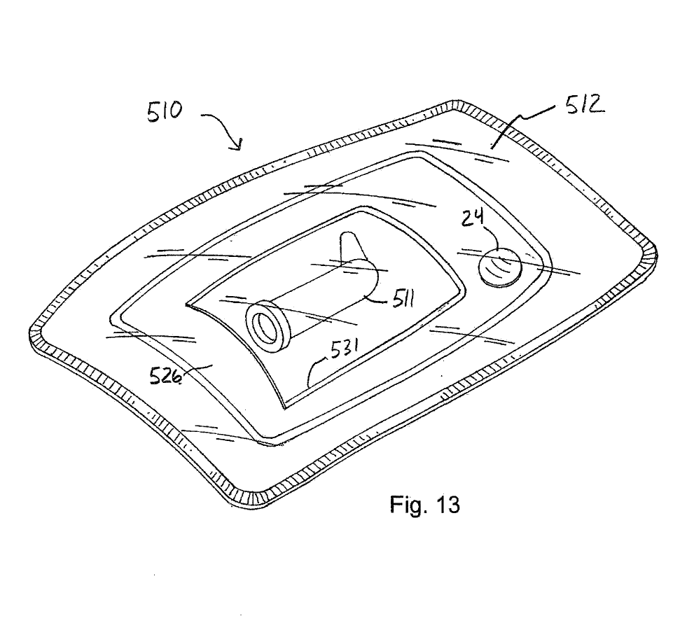

FIGS. 12A-B illustrate another embodiment of the present invention. In this embodiment a separate heating material container is contained within the self-heating product pouch. The self-heating product pouch 410 has a top portion 412 that is removable from a bottom portion or body 416. The top portion 412 may be removed easily from the bottom portion or body 416 with the assistance of slits 436 providing easy tearing so as to open the self-heating product pouch 410. The top portion 412 may also comprise a heat retaining material or insulation. Contained within the self-heating product pouch 410 is a heating material container 426 having a heating material 430 contained therein. The heating material container 426 may be made of a plastic material that is transparent or translucent. The heating material 430 is activated by activator or trigger 24 contained within the heating material container 426 and in contact with the heating material 430. Preferably, a portion of the self-heating product pouch 410 is made of a transparent or translucent material so that the activator or trigger 24 is visible when the self-heating product pouch 410 is sealed. Additionally, a portion of the self-heating product pouch 410 may be made of a reflective material or a coating of an infrared or heat reflecting material to prevent heat loss when the heating material 430 is activated. The self-heating product pouch 410 may also have a heat insulating coating or material contained therein or on to provide heat retention. The capsule 411 with a dental material 413 therein is placed on the heating material container 426 contained within the self-heating product pouch 410. A heat sensitive ink or paint may be used to indicate when the pouch or capsule 411 has reached a desired temperature. A heat sensitive ink or paint 415A may be printed on the capsule 411 or heat sensitive ink or paint 415B may be printed on the pouch 410. The heat sensitive ink or paint may be formulated to change color at any desired predetermined temperature. Therefore, the heat sensitive ink or paint provides visual confirmation that the dental material 413 has reached a desired temperature.

In operation, prior to a dental procedure in which the capsule 411 is to be used, the heating material 430 is activated by bending the activator or trigger 24 contained within the heating material container 426. The activator or trigger 24 may be located when in the sealed self-heating product pouch 410 by feeling for the activator or trigger 24 or visually when a portion of the heating material container 426 and the self-heating product pouch 410 are transparent or translucent. After activation of the heating material 430 the heating material generates a predetermined desired temperature heating the capsule 411 and the dental material 413 contained therein. The heating of the dental material 413 improves its flowability and enhances its physical properties. After heating of the capsule 411 and the dental material 413 contained therein the self-heating product pouch 410 may be opened and the capsule 411 removed and placed in a suitable applicator device, such as a dental syringe.

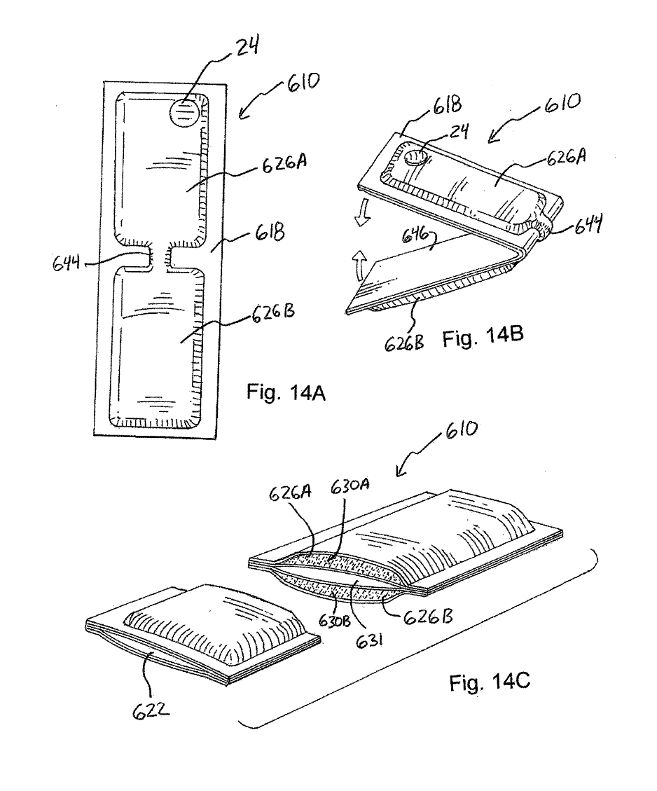

FIG. 13 illustrates another embodiment of the present invention. In this embodiment a capsule pocket 531 holds the capsule 511 in place on the heating material container 526 within the self-heating product pouch 510. The capsule pocket 531 may be a depression in the heating material container 526 or have a material covering a portion of the heating material container 526 with an opening. The activator or trigger 24 activates the heating material contained within the heating material container 526.

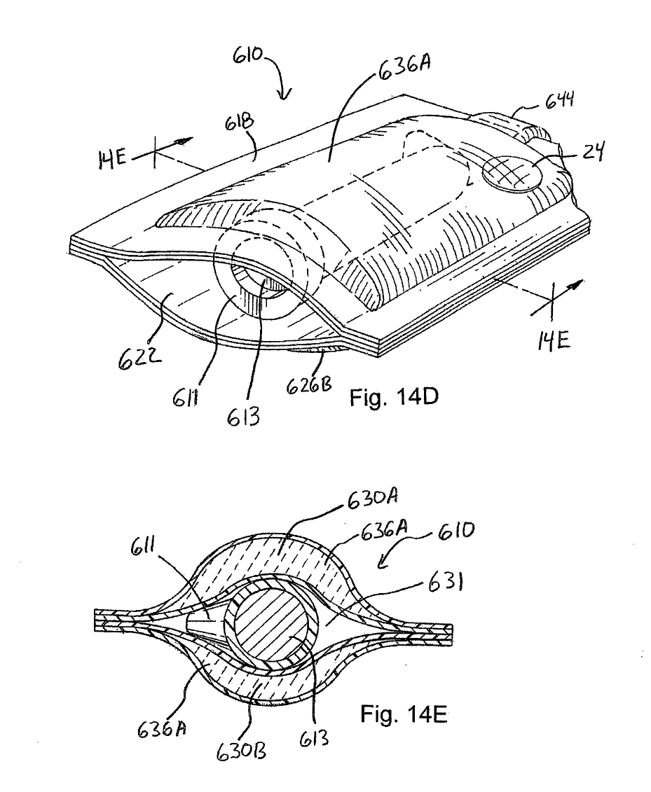

FIGS. 14A-E illustrate another embodiment of the present invention. In this embodiment an upper and lower heating material container is used. The twin chamber self-heating product pouch 610 comprises an upper heating material container 626A and a lower heating material container 626B separated by a channel 644. Sealed edges 618 seal the perimeter of the upper and lower heating material containers 626A and 626B; except for the channel 644. The channel 644 is located substantially centrally or in the middle of the twin chamber self-heating product pouch 610 and permits communication between the two upper and lower heating material containers 626A and 626B.

FIG. 14B illustrates the formation of a central pocket by folding over the upper heating material container 626A over the lower heating material container 626B about the channel 644. The peripheral edges of the upper and lower heating material containers 626A and 626B may be attached by any attachment means, such as a contact adhesive 646. The upper and lower heating material containers 626A and 626B may be attached mechanical means, such as a clip not illustrated.

FIG. 14C is a section illustrating the formation of the central pocket 631 between the upper heating material container 626A and the lower heating material container 626B. A heating material 638A is placed within the upper heating material container 626A and a heating material 638B is placed within the upper heating material container 626B. The heating materials 630A and 630B our activated by activator or trigger 24 contained in one of the heating material containers 626A or 626B, is illustrated in FIGS. 14A-B. On one edge of the twin chamber self-heating product pouch 610 is a pocket opening 622. A capsule, not illustrated, is placed within the pocket opening 622.

FIG. 14D illustrates a capsule 611 containing a dental material 613 place within the pocket opening 622. the dental material 613 may be any dental material, but is preferably a dental composite that will have improved properties after being heated.

FIG. 14E is a cross section taken along line 14E-14E in FIG. 14D and clearly illustrates the capsule 611 placed within the pocket 631 and the dental material 613 placed therein.

In the embodiment illustrated in FIGS. 14A-E the capsule 611 and dental material 613 therein to be heated is advantageously surrounded on both sides by upper and lower heating materials 630A and 630B. Upon activation of the heating material 630A in the upper heating material container 636A by activator or trigger 24, the nucleation process of the heating material 630A passes through the channel 644 to activate the heating material 630B contained in lower heating material container 626B.

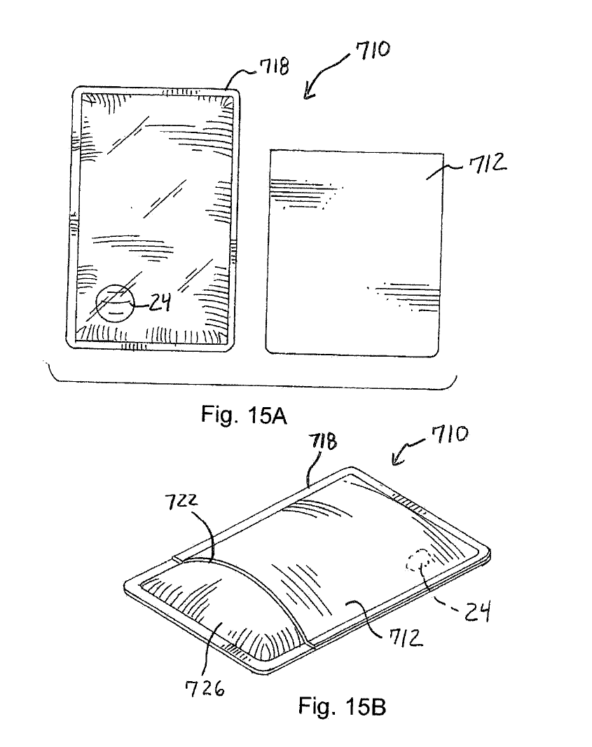

FIGS. 15A-B illustrate another embodiment of the present invention. This embodiment is similar to the embodiment illustrated in FIGS. 7A-B, however, the embodiment illustrated in FIGS. 15A-B only have a partial cover. The self-heating product pouch 710 has a sealed pouch chamber 726 that has a self-heating material and an activator or trigger 24 contained therein. Cover 712 is placed over the sealed pouch chamber 726 and has a perimeter seal 718. The cover 712 only covers a portion of the sealed pouch chamber 726. A pocket opening 722 is formed adjacent the surface of the sealed pouch chamber 726. A product, such as a dental capsule, may be easily slid within the pocket opening 722.

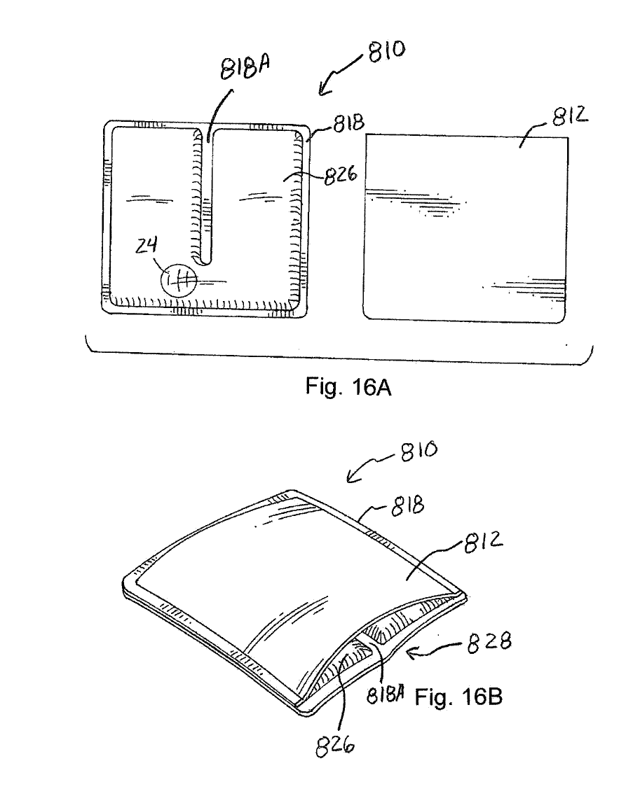

FIGS. 16A-B illustrate another embodiment of the present invention. In this embodiment a center seal provides additional space for a pocket. The self-heating product pouch 810 has a sealed pouch chamber 826 with the self-heating material and activator or trigger 24 contained therein. The sealed pouch chamber 826 has a perimeter seal 818. A center seal 818A is formed along a portion of the length of the sealed pouch chamber 826 providing continuity to the different sections formed by the center seal 818A. A cover 812 is placed over and sealed to three sides of the sealed pouch chamber 826 forming a pocket opening 822. The center seal 818A permits a pocket 828 to be formed between the cover 812 and the top surface of the sealed pouch chamber 826. This permits easier placement of a product, such as a dental capsule, to be heated by the covered self-heating product pouch 810.

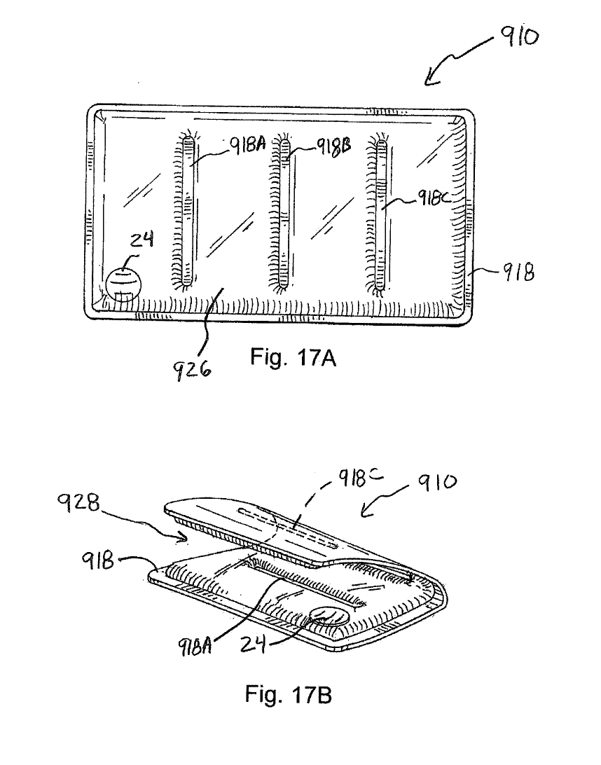

FIGS. 17A-B illustrate yet another embodiment of the present invention. This embodiment is similar to the embodiment illustrated in FIG. 8, but has seals that only partially divide a chamber into sections providing continuity to a heating material contained therein facilitating activation. The folded self-heating product pouch 910 has a premier seal 918 and two partial offset seals 918A and 918C with a partial center seal 918B there between. The activator or trigger 24 is contained within the divided sealed pouch chamber 926 together with a self-heating material. As illustrated in FIG. 17B, the sealed pouch chamber 926 may be folded over onto itself so that the offset seals 918A and 918C are placed adjacent to each other forming a pocket space 928. This pocket space 928 provides a space for a product to be placed, such as a dental capsule. Upon manipulation of the activator or trigger 24 within the sealed pouch chamber 926 the self-heating material will be activated in all of the sections separated by the partial seals 918A, 918B, 918C due to the continuity of the sections with the chamber. The folded over portion of the self-heating product pouch 910 maybe held together by any convenient attachment means, such as adhesive, a clip, or elastic. The folded self-heating product pouch 910 may also be sufficiently compliant so that it will remain folded without any additional securing.

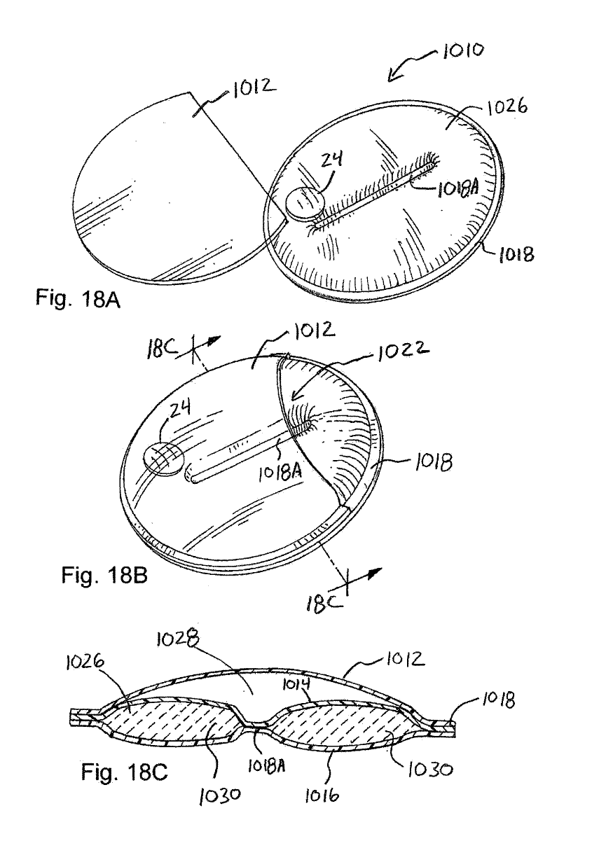

FIGS. 18A-C illustrate yet another embodiment of the present invention. This embodiment is similar to the embodiment illustrated in FIGS. 16A-B, but is round and only has a partial cover. The round covered self-heating product pouch 1010 has a cover 1012 partially covering the top surface of the sealed pouch chamber 1026 containing the self-heating material and activator or trigger 24. The sealed pouch chamber 1026 has a perimeter seal 1018. Formed approximately in the center of the sealed pouch chamber 1026 is a partial center seal 1018A extending partially along a diameter of the sealed pouch chamber 1026 forming two sections. The partial center seal 1018A provides continuity between the two sections and permits activation of all of the self-heating material contained within the sealed pouch chamber 1026 upon activation by manipulation of the trigger or activator 24. As illustrated in FIG. 18C, a self-heating material 1030 is contained between a top layer 1014 and a bottom layer 1016 and is partially separated into the two sections by partial center seal 1018A. The partial center seal 1018A causes the formation of a pocket space 1028 to be formed between the partial center seal 1018A and the cover layer 1012. The pocket space 1028 has a space opening 1022. This provides an opening and space for the easy placement of a product, such as a dental capsule, to be heated.

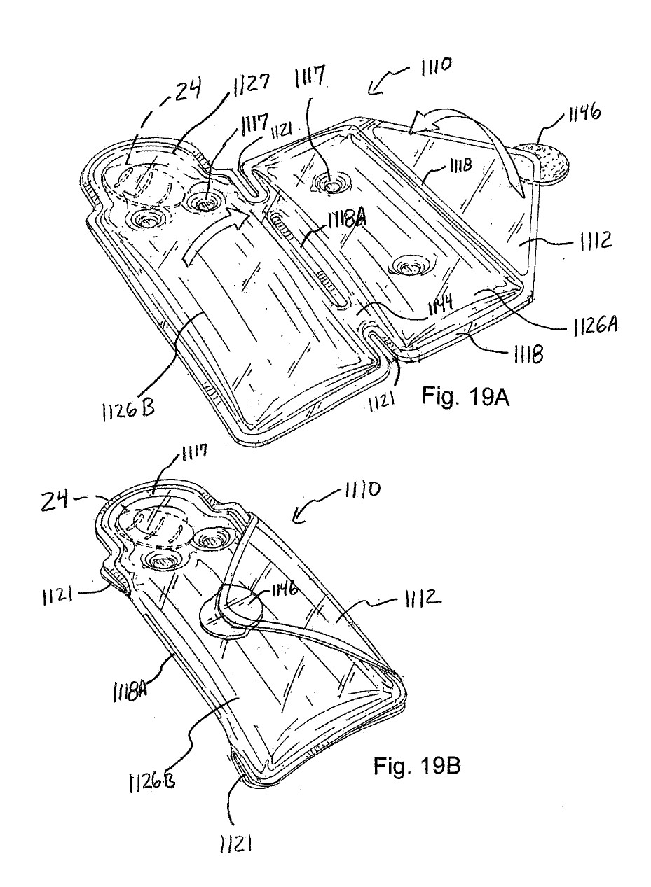

FIGS. 19A-19B illustrate a preferred embodiment of the present invention. In this embodiment a flexible transparent plastic is used to form the transparent folded self-heating pouch 1110. The folded self-heating pouch 1110 has a folded cover 1112 attached to an adjacent sealed pouch chamber 1126A filled with a liquid self-heating material that when triggered by trigger 24 has an exothermic chemical reaction generating heat. Adjacent to the sealed pouch chamber 1126A is another sealed pouch chamber 1126B. The sealed pouch chamber's 1126A and 1126B have channels 1144 communicating there between. A central seal 1118A is placed between the two sealed pouch chamber's 1126A and 1126B. Also place between the sealed pouch chamber's 1126A and 1126B and adjacent an edge thereof are edge openings 1121. The perimeter of the sealed pouch chamber's 1126A and 1126B have a perimeter seal 1118. The sealed pouch chamber 1126 a has internal seals 1117 and the sealed pouch chamber 1126B has internal seals 1117 placed adjacent an extension 1127 containing self-heating material activating trigger 24. An attachment means 1146, such as an adhesive, hook and loop fasteners, magnet, or other equivalent fastener's is attached to a distal end of the folded cover 1112.

When the self-heating pouch 1110 is folded as illustrated by the arrow the folded cover 1112 holds the two sealed pouch chamber's 1126A and 1126B together forming a pocket in which a capsule may be placed. The edge openings 1121 facilitate insertion of a capsule by providing some compliance facilitating insertion of the capsule. Once folded, the self-heating pouch 1110 may be activated by easily bending or manipulating the activator or trigger 24 initiating the chemical exothermic reaction in the self-heating material contained therein. The extension 1127 positioning the activator or trigger 24 outside of the folded self-heating pouch 1110 facilitates easy triggering of the self-heating material after the self-heating pouch 1110 has been folded. The internal seals 1117 formed on the sealed pouch chamber 1126A aid in the formation of a pocket facilitating insertion of the capsule.

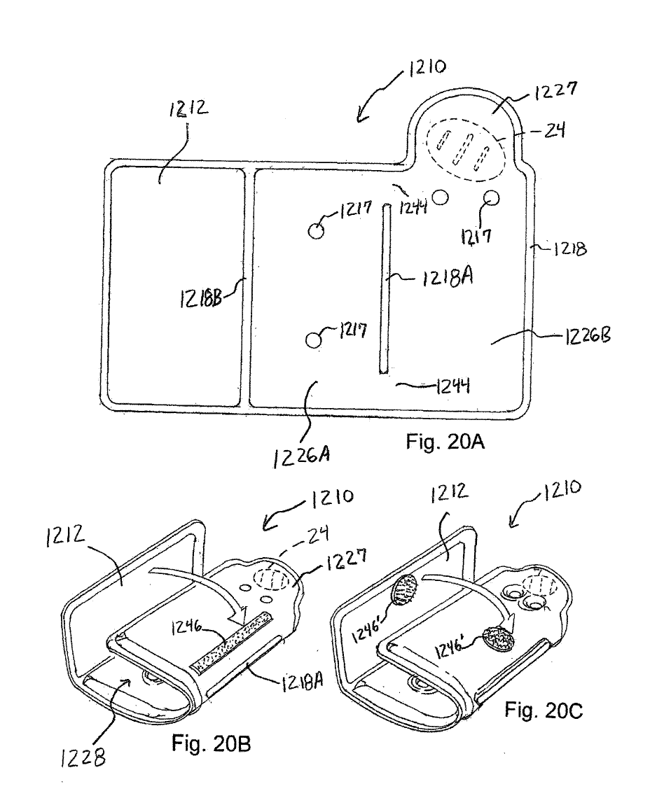

FIGS. 20A-B illustrate another embodiment similar to that illustrated in FIGS. 19A-B, but with a different shaped folded cover 1212. The folded self-heating pouch 1210 has a folded cover 1212 with sealed pouch chamber's 1226A and 1226B having a perimeter seal 1218. A central seal 1218B separates the cover 1212 from the sealed pouch chamber 1226A. separating the sealed pouch chamber 1226A and 1226B is a central seal 1218A. On either end of the central seal 1218A are channels 1244 permitting communication between the sealed pouch chamber's 1226A and 1226B. Extending from the sealed pouch chamber 1226B is an extension 1227 holding activator or trigger 24 therein. Internal seals 1217 formed on the sealed pouch chamber 1226B adjacent to the extension 1227 aid in retaining the activator or trigger 24 within the extension 1227. FIG. 20B illustrates attachment means 1246, which may be a pressure sensitive adhesive or other equivalent fastener. FIG. 20C illustrates an attachment means 1246′, which may be a hook and loop fastener or other equivalent fastener for securing or fastening the cover 1212 to the sealed pouch chamber 1226B.

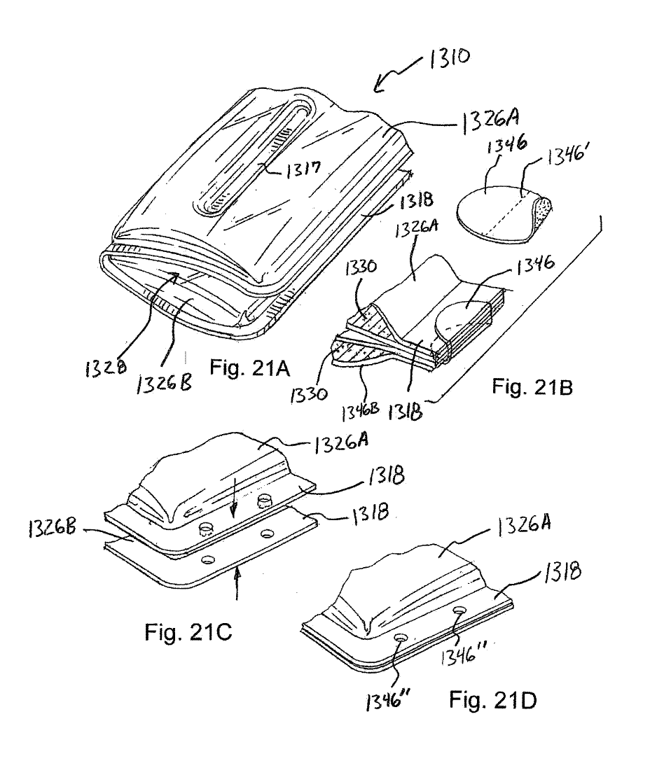

FIGS. 21A-D schematically illustrate different attachment means. Folded self-heating pouch 1310 has a sealed pouch chamber 1326A and a sealed pouch chamber 1326B folded so as to form a pocket space 1328 there between. The sealed pouch chamber 1326A may have an internal seal 1317 therein. A perimeter seal 1318 seals the sealed pouch chamber's 1326A and 1326B. FIG. 21B illustrates the attachment means as a pressure sensitive adhesive tab 1346 having a frangible seal 1346′. The pressure sensitive adhesive tab 1346, when placed around the perimeter seals 1318, holds the folded self-heating pouch 1310 closed. The folded self-heating pouch 1310 may be opened by breaking the frangible seal 1346′. FIGS. 21C-D illustrate an attachment means of a releasable tack weld 1346″. When the perimeter seals 1318 are placed together heat and pressure may be applied thereto to gently tack weld the sealed pouch chamber's 1326A and 1326B together so as to form a pocket. The tack weld 1346″ may be releasable so that the folded self-heating pouch 1310 may be opened.

The self-heating product pouch of the present invention may be used to heat or warm other products or materials, such as an anesthetic carpule.

The present invention provides an easy and convenient device and method for heating dental composites contained within a capsule that can be easily heated at chair side and on demand when needed. The present invention also assures that the material to be heated is not overheated because it can only be heated to a temperature of the heating material. For a heating material comprised of sodium acetate trihydrate the heating temperature is limited to approximately 137° F. or 58° C., the melting point of the heating material. This makes dentistry easier.

The present invention provides a convenient and economical way to heat a dental material making dentistry easier.

What is claimed is:

1. A self-heating device for heating a material comprising:
a sleeve adapted to be placed over a container containing the material; and
a chemically activated heating material placed within said sleeve,
whereby when said chemically activated heating material is activated an exothermic reaction results heating the container and the material.

2. A device as in claim 1 wherein:
said chemically activated heating material comprises a supersaturated solution.

3. A device as in claim 2 wherein:
the supersaturated solution comprises a solution of sodium acetate trihydrate.

4. A device as in claim 2 wherein:
the chemically activated heating material is activated by exposure to air.

5. A device as in claim 1 wherein:
the material is a dental material.

6. A device as in claim 1 wherein:
said self-heating sleeve comprises a tube.

7. A self-heating product pouch comprising:
a product pocket adapted to receive a product to be heated;
a heating material pocket placed adjacent said product pocket;
a heating material that is chemically activated placed within said heating material pocket; and
a heating material trigger,
whereby the heating material may be selectively activated by said heating material trigger and the product may be heated prior to use.

8. A self-heating product pouch as in claim 7 wherein:
said heating material comprises a solution of sodium acetate trihydrate.

9. A self-heating product pouch as in claim 7 wherein:
the product comprises a dental capsule containing a dental material.

10. A self-heating product pouch comprising:
a pouch having a removable cover portion;
a heating material container contained in said pouch;
a heating material contained within said heating material container;
an activator in contact with said heating material, whereby said activator selectively activates said heating material contained within said heating material container; and
a product placed on said heating material container;
whereby said product is heated upon activation of said heating material and is capable of being removed from said pouch by removing the removable cover portion.

11. A self-heating product pouch as in claim 10 wherein:
said product comprises a dental capsule containing a dental material.

12. A self-heating product pouch as in claim 11 wherein:
the dental material comprises a dental composite.

13. A self-heating product pouch as in claim 10 wherein:
the removable cover portion comprises a heat retaining material preventing heat loss from said heating material container.

14. A multiple chamber self-heating product pouch comprising:
an upper heating material container;
a lower heating material container;
a channel coupling said upper heating material container to said lower heating material container;
a heating material placed within said upper and lower heating material containers, said heating material being capable of generating heat upon activation; and
a trigger contacting said heating material, wherein said heating material is selectively activated,
whereby said upper heating material container is capable of being folded over said lower heating material container forming a pouch.

15. A multiple chamber self-heating product pouch as in claim 14 wherein:
said heating material comprises a solution of sodium acetate trihydrate.

16. A foldable self-heating sleeve forming a pocket comprising:
a cover;
a first sealed pouch chamber attached to said cover along one edge;
a second sealed pouch chamber attach to said first sealed pouch chamber along one edge;
an extension extending from an edge of said second sealed pouch chamber;
a channel connecting said first sealed pouch chamber with said second sealed pouch chamber;
a chemically activated heating material contained within said first and second sealed pouch chamber's;
an activating trigger sealed within said extension in contact with said chemically activated heating material, whereby when said activating trigger activates said chemically activated heating material and exothermic reaction occurs producing heat; and
attachment means, attached to said cover, for attaching said cover to said second sealed pouch chamber,
whereby the pocket is formed between the first and second sealed pouch chamber's when folded together and a container having a material therein is capable of being placed within the pocket to be heated by the chemically activated heating material.

17. A foldable self-heating sleeve forming a pocket as in claim 16 wherein:
said chemically activated heating material comprises a supersaturated solution of solution of sodium acetate trihydrate.

18. A foldable self-heating sleeve forming a pocket as in claim 16 further comprising:
a dental tip filled with dental material placed within said pocket.

19. A self-heating sleeve for placing over a barrel of a dental syringe comprising:
a cylinder having an outer wall and an inner wall, the inner wall forming a bore, said bore having a diameter adapted to fit over the barrel of the dental syringe and a length sufficient to cover a portion of the barrel and a dental cartridge held therein; and
a heating material generating heat caused by a chemical reaction contained between the outer and inner wall of said cylinder,
whereby upon activation of said heating material heat is generated.

20. A method of heating a dental material comprising the steps of:
placing a heat generating chemically activated material within a sleeve;
activating the heat generating chemically activated material;
placing the sleeve over a dental cartridge containing a dental material; and
dispensing the dental material after the dental material has reached a predetermined temperature.
